(19) United States
(12) Patent Application Publication
(10) Pub. No.: US 2017/0264827 A1
(43) Pub. Date: Sep. 14, 2017

(54) MOTION-SENSOR BASED REMOTE CONTROL

(71) Applicant: Xiaoyi Technology Co., Ltd., Shanghai (CN)

(72) Inventor: Eric DAO, Shanghai (CN)

(73) Assignee: Xiaoyi Technology Co., Ltd.

(21) Appl. No.: 15/166,314

(22) Filed: May 27, 2016

(30) Foreign Application Priority Data
Mar. 8, 2016 (CN) 201610129080.X

(51) Int. Cl. H04N 5/232; H04N 21/4223; H04N 21/41; H04W 4/02; H04N 21/643

(52) U.S. Cl. CPC H04N 5/23296; H04W 4/027; H04N 5/23206; H04N 5/23216; H04N 21/64322; H04N 21/4126; H04N 21/4223

(57) ABSTRACT

Devices and methods for performing motion-sensor based remote control are disclosed. According to certain embodiments, a terminal includes a sensor configured to generate a signal indicative of a motion parameter of the terminal. The terminal also includes a memory storing instructions. The terminal further includes a processor configured to execute the instructions to: determine the motion parameter based on the signal generated by the sensor; and control a smart device to move according to the motion parameter.

### CROSS-REFERENCE TO RELATED APPLICATIONS

This application is based upon and claims priority to Chinese Patent Application No. 201610129080.X, filed Mar. 8, 2016, the entire contents of which are incorporated herein by reference.

### TECHNICAL FIELD

The present disclosure relates generally to the field of device control technologies, and more particularly, to a remote control method and device based on a motion sensor.

### BACKGROUND

With more and more devices being created to make people's jobs and lives easier, there has been always a high demand for convenient ways to control the devices. For example, pan-tilt-zoom (PTZ) Internet-protocol (IP) cameras allow individuals and businesses to monitor premises for various purposes, including, for example, security, baby or elderly monitoring, videoconference, or the like. A user often uses a terminal, such as a mobile phone or a computer, to remotely control the camera's PTZ movements for enhanced viewing.

Typically, the terminal may display a control dialog with arrows and keys or enable a touch screen, for the user to control the camera. Such control schemes, however, may be cumbersome to use. First, the control dialog and the touch screen reduce the available screen area for displaying the images shot by the camera. Moreover, arrows and screen swiping are difficult to precisely control the panning and tilting speeds of the camera. Furthermore, it may take multiple steps for the user to navigate the camera to a desired location, such as when a combination of panning and tilting is required. In addition, when a mobile phone is used to control the camera, it is often difficult to use the control dialog or touch screen with one hand.

The disclosed methods and systems address one or more of the problems listed above.

### SUMMARY

Consistent with one disclosed embodiment of the present disclosure, a terminal is provided for controlling a smart device. The terminal includes a sensor configured to generate a signal indicative of a motion parameter of the terminal. The terminal also includes a memory storing instructions. The terminal further includes a processor configured to execute the instructions to: determine the motion parameter based on the signal generated by the sensor; and control a smart device to move according to the motion parameter.

Consistent with another disclosed embodiment of the present disclosure, a method is provided for controlling a smart device. The method includes generating a signal indicative of a motion parameter of a terminal. The method also includes determining the motion parameter based on the signal. The method further includes controlling the smart device to move according to the motion parameter.

Consistent with yet another disclosed embodiment of the present disclosure, a non-transitory computer-readable storage medium storing instructions for controlling a smart device is provided. The instructions cause a processor to perform certain operations. The operations include generating a signal indicative of a motion parameter of a terminal. The operations also include determining the motion parameter based on the signal. The operations further include controlling the smart device to move according to the motion parameter.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram illustrating an implementation environment for performing motion-sensor based remote control, according to an exemplary embodiment.

FIG. 2 is a schematic diagram illustrating a control menu for navigating a smart device using keys and directional arrows.

FIG. 3 is a block diagram of a terminal for controlling a smart device, according to an exemplary embodiment.

FIG. 4 is a flowchart of a method for controlling a smart device, according to an exemplary embodiment.

FIG. 5 is a schematic diagram illustrating an implementation of the method shown in FIG. 4, according to an exemplary embodiment.

FIG. 6 is a schematic diagram illustrating an implementation of the method shown in FIG. 4, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

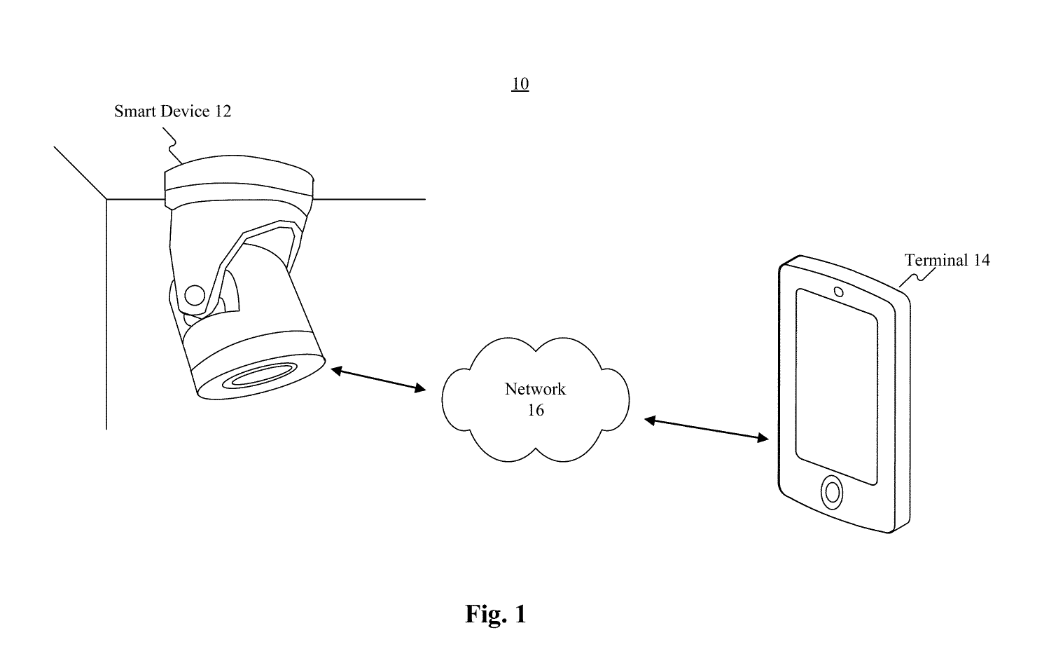

FIG. 1 is a schematic diagram illustrating an exemplary implementation environment 10 for the disclosed embodiments. Referring to FIG. 1, implementation environment 10 may include a smart device 12, a terminal 14, and a network 16.

Smart device 12 is a device that may be remotely controlled by another device to perform certain functions. For example, smart device 12 may be a smart camera, a smart TV, a smart air conditioner, a smart air purifier, a smart refrigerator, a smart door bell, a smart etc.

Terminal 14 may be an electronic device capable of remotely controlling smart device 12. Terminal 14 may be, for example, a mobile phone, a wearable device (for example, a smart watch, a pair of smart glasses, etc.), a tablet computer, a personal computer, a personal digital assistant (PDA), a remote controller, a medical device, exercise equipment, an ebook reader, etc.

Terminal 14 may include a user interface through which a user may control smart device 12. For example, terminal 14 may have a keyboard or a touch screen through which the user may enter various commands for controlling smart device 12.

Terminal 14 may also include one or more built-in sensors capable of sensing a motion of terminal 14. Exemplary motion sensors may include a gyro sensor, an accelerometer, etc. Based on motion data generated by the motion sensors, terminal 14 may determine a user motion and control smart device 12 according to the user motion. The user motion may be one of various gestures/actions made by the user.

Smart device 12 and terminal 14 may communicate with each other in a wired or wireless manner. For example, each of smart device 12 and terminal 14 may include a built-in Wi-Fi module or Bluetooth antenna for wireless connection. Also for example, each of smart device 12 and terminal 14 may include a universal serial bus (USB) interface to receive a data cable. In exemplary embodiment, smart device 12 and terminal 14 may communicate over network 16. Network 16 may be any type of wired or wireless network that may allow transmitting and receiving data. For example, network 16 may be a nationwide cellular network, the Internet, a local wireless network (e.g., Bluetooth or Wi-Fi), or a wired network.

For illustration purpose only, the following description assumes smart device 12 to be a PTZ camera and terminal 14 to be a mobile phone. However, it is contemplated that the disclosed embodiments may be applied to any types of smart devices 12 and terminals 14.

The PTZ camera may be an IP camera connected to other devices, such as a mobile phone, a server, and a display device, via network 16. The PTZ camera may have a web server application embedded in the camera. The web server has a unique uniform resource locator (URL), which may allow the PTZ camera's live image stream to be viewed remotely through any web browser or other web-enabled application. The web browser communicates directly with the PTZ camera's dedicated web server using a common web protocol such as hypertext transfer protocol (HTTP) or real time protocol (RTP). The mobile phone may be installed with various software applications that allow the mobile phone to remotely view the PTZ camera's live image stream through the embedded web browser on the mobile phone.

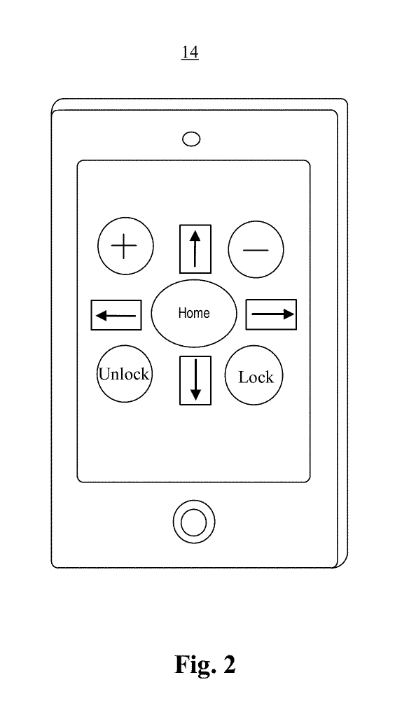

The PTZ camera may be equipped with one or more motors to enable smooth and continuous movement of the PTZ camera, so as to provide 360-degree panning in a horizontal plane, 180-degree titling in a vertical plane, and zooming in and out. The applications installed on the mobile phone may also allow the mobile phone to remotely control the PTZ camera's available PTZ movements. For example, these applications may provide a control menu showing various arrows and/or keys for the user to navigate the PTZ camera. FIG. 2 is a schematic diagram illustrating a control menu for navigating the PTZ camera using keys and directional arrows. Referring to FIG. 2, the control menu is displayed on the touch screen of the mobile phone (i.e., terminal 14). The control menu may provide the control options as summarized in Table 1 below.

TABLE 1

| Navigation Arrow/Key | PTZ Movement |
|---|---|
| → | Pan the camera to the right |
| ← | Pan the camera to the left |
| ↑ | Tilt the camera up |
| ↓ | Tilt the camera down |
| + | Zoom in |
| − | Zoom out |
| Home | Restore the camera to its original position |
| Lock | Lock the pose of the camera |
| Unlock | Unlock the pose of the camera |

Referring to Table 1, the control interface may allow the user to move the PTZ camera by pushing the corresponding keys and directional arrows. In some embodiments, the mobile phone may also allow the user to swipe on the touch screen to control the moving directions of the PTZ camera.

For another example, the mobile phone may display a keyboard (not shown in FIG. 2) on the touch screen and allow the user to use customized hot keys to navigate the PTZ camera. In one embodiment, pushing the “P” key once on the keyboard may cause the camera to pan from side-to-side; pushing the “T” key once on the keyboard may cause the camera to tilt up and down; pushing the “I” key once on the keyboard may cause the camera to zoom in; and pushing the “O” key once on the keyboard may cause the camera to zoom out. The user may also access a user help window on the touch screen to view a list of the available hot keys.

The PTZ control based on the control menu and keyboard, however, may have several limitations. First, showing the control menu and keyboard reduces the available screen area for displaying the images shot by the PTZ camera. This problem may be exuberated when terminal 14 is, for example, a mobile phone, whose screen is in a small size. In particular, the small size of the mobile phone may require the control menu or keyboard being displayed in a full-screen mode, thereby preventing the user from simultaneously viewing the images. Second, the directional arrows, screen swiping, keyboard may lack the features for the user to control the moving of speed the PTZ camera. Moreover, the magnitude of the PTZ movement is usually set to be proportional to the time during for which the user presses an arrow/key. It is therefore easy for the user to over- or under-compensate the movement. Third, when the camera movement consists of a combination of panning and titling, the user may have to operate multiple arrows and/or keys in multiple steps. Fourth, it may be difficult for the user to use only one hand to operate the arrows, screen swiping, and keyboard. Therefore, it can be seen that the control scheme based on the control menu and keyboard may be cumbersome to use.

As described below, in exemplary embodiments consistent with the present disclosure, terminal 14 may employ a motion-sensor based system for navigating the PTZ camera (i.e., smart device 12). This way, the user may navigate the PTZ camera by moving terminal 14.

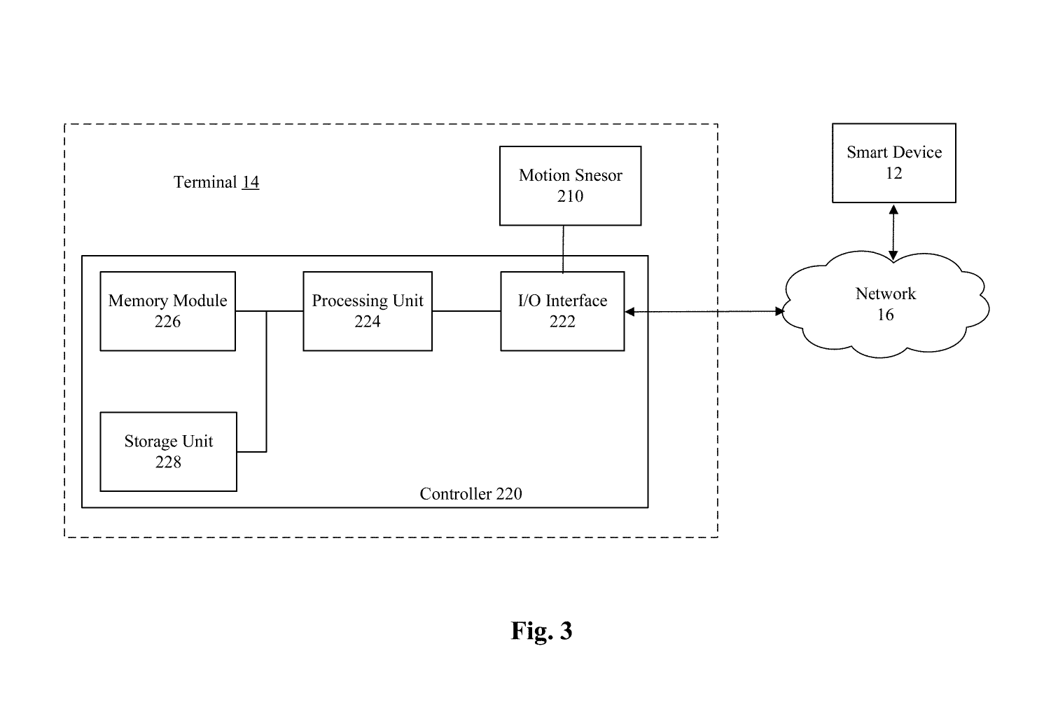

FIG. 3 provides a block diagram of an exemplary terminal 14 that may be used for controlling a smart device 12. For example, smart device 12 may be a PTZ camera and terminal 14 may be configured to control the PTZ movement of smart device 12. As illustrated in FIG. 3, exemplary terminal 14 may include a motion sensor 210, and a controller 220.

Motion sensor 210 may include any device capable of generating signals indicative of a motion parameter of terminal 14. The motion parameter may include, but not limited to, an angular velocity, a linear acceleration, a linear velocity, a heading (i.e., a moving direction) of terminal 14. In exemplary embodiments, motion sensor 210 may include a gyro sensor configured to generate signals indicative of an angle or an angular velocity of terminal 14. The gyro sensor may be a 3-axis gyro sensor that detects, in the form of voltage values, the angular velocity in the x, y, and z directions (i.e., the pitch rate, yaw rate, and roll rate of terminal 14). The gyro sensor can supply the generated angular-velocity data to controller 220.

In some embodiments, motion sensor 210 may further include an accelerometer configured to detect a linear acceleration of terminal 14 in the form of a voltage value. The accelerometer may be a 3-axis accelerometer configured to generate signals indicative of the acceleration of terminal 14 in the x, y, and z directions. The accelerometer can supply the generated acceleration data to controller 220. The gyro sensor and accelerometer may be integrated into an inertial measurement unit (IMU) in terminal 14. For example, the IMU may be a 6-degree of freedom (6 DOF) IMU consisting of a 3-axis gyro sensor, a 3-axis accelerometer, and sometimes a 2-axis inclinometer.

Although the following description assumes motion sensor 210 to include a gyro sensor and/or an accelerometer, it is contemplated that motion sensor 210 may include any type and number of sensors capable of detecting a motion parameter of terminal 14. In one embodiment consistent with the present disclosure, motion sensor 210 may also include a magnetometer (or compass) configured to sense the orientation of terminal 14 in elation to the Earth's magnetic field. In another embodiment, motion sensor 210 may also include a perception sensor configured to generate scene data describing a physical environment in the vicinity of terminal 14. The perception sensor may embody a device that detects and ranges objects located 360 degrees around terminal 14. For example, the perception sensor may be embodied by a light detection and ranging (LIDAR) device, a radio detection and ranging (RADAR) device, a sound navigation and ranging (SONAR) device, a camera, or any other device known in the art. In one example, the perception sensor may include an emitter that emits a detection beam, and an associated receiver that receives a reflection of that detection beam. Based on characteristics of the reflected beam, a distance and a direction from an actual sensing location of the perception sensor on terminal 14 to a portion of a sensed physical object may be determined. By utilizing beams in a plurality of directions, the perception sensor may generate a picture of the surroundings of terminal 14. The change of the surroundings may indicate the movement of terminal 14.

Controller 220 may be implemented with one or more application-specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing functions consistent with the present disclosure. Controller 220 may include, among other things, an input/output (I/O) interface 222, a processing unit 224, a memory module 226, and/or a storage unit 228. These units may be configured to transfer data and send or receive instructions between or among each other.

I/O interface 222 may be configured for two-way communication between controller 220 and various devices. As depicted in FIG. 3, for example, I/O interface 222 may provide an interface between the processing unit 224 and motion sensor 210 and be configured to relay the signals generated by motion sensor 210 to processing unit 224 for further processing. For another example, I/O interface 222 may send, via network 16, control commands generated by processing unit 224 to smart device 12 for controlling the PTZ movement of smart device 12. I/O interface 222 can access network 16 based on one or more communication standards, such as Wi-Fi, LTE, 2G, 3G, 4G, 5G, etc. In one exemplary embodiment, I/O interface 222 may further include a near field communication (NFC) module to facilitate short-range communications between terminal 14 and smart device 12. In other embodiments, I/O interface 222 may be implemented based on a radio frequency identification (RFID) technology, an infrared data association (IrDA) technology, an ultra-wideband (UWB) technology, a Bluetooth (BT) technology, or other technologies.

Processing unit 224 may include any appropriate type of general purpose or special-purpose microprocessor, digital signal processor, or microprocessor. Processing unit 224 may be configured as a separate processor module dedicated to control the PTZ movement of smart device 12 based on the movement of terminal 14. Alternatively, processing unit 224 may be configured as a shared processor module for performing other functions of terminal 14 unrelated to the controlling of smart device 12.

Processing unit 224 may be configured to receive signals from motion sensor 210 and process the signals to determine a plurality of parameters regarding the movement of terminal 14, including the motion parameters and the pose of terminal 14. The motion parameter may include the angular velocity, the linear acceleration, the linear velocity, and the heading of terminal 14. The pose may include the position and the attitude (i.e., angular orientation) of terminal 14. Based on the parameters, processing unit 224 may further generate and transmit command signals, via I/O interface 222, to control the PTZ movement of smart device 12. The command signals, for example, may instruct one or more motors in smart device 12 to drive smart device 12 in a desired manner.

Processing unit 224 may be configured to control the panning and tilting of smart device 12 based on the angular velocities and/or angular orientation of terminal 14. For example, when processing unit 224 determines a yaw rate of terminal 14 based on the signals generated by motion sensor 210, processing unit 224 may control smart device 12 to pan to the right or left according to the direction and the magnitude of the yaw rate of terminal 14. Similarly, when processing unit 224 determines a pitch rate of terminal 14 based on the signals generated by motion sensor 210, processing unit 224 may control smart device 12 to tilt up or down according to the direction and the magnitude of the pitch rate of terminal 14. Moreover, when processing unit 224 determines that terminal 14 has both a non-zero yaw rate and a non-zero pitch rate, processing unit 224 may control smart device 12 to pan and tilt simultaneously.

Processing unit 224 may also be configured to control the pose of smart device 12 according to the pose of terminal 14. For example, after the pose of terminal 14 is determined, processing unit 224 may determine a target pose for smart device 12 according to a predetermined corresponding relationship between poses of terminal 14 and poses of smart device 12. Processing unit 224 may then control smart device 12 to move to the target pose.

Processing unit 224 may also be configured to control other features of smart device 12 based on the motion parameters and/or pose of terminal 14. For example, when smart device 12 is a camera, processing unit 224 may control smart device 12 to zoom in or out according to the motion parameters and/or pose of terminal 14. In one embodiment, processing unit 224 may determine the direction of the linear acceleration of terminal 14. If terminal 14 is accelerating to a first predetermined direction, such as moving toward a user of terminal 14, terminal 14 may cause smart device 12 to zoom in. If terminal 14 is accelerating to a second predetermined direction, such as moving away from the user, terminal 14 may cause smart device 12 to zoom out.

Memory module 226 and storage unit 228 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, or a magnetic or optical disk.

Memory module 226 and/or storage unit 228 may be configured to store one or more computer programs that, when executed by processing unit 224, perform various procedures, operations, or processes consistent with the disclosed embodiments. For example, memory module 226 and/or storage unit 228 may be configured to store software used by processing unit 224 to determine the motion parameters and pose of terminal 14, and to navigate smart device 12 based on the determined motion parameters and pose. Memory module 226 and/or storage unit 228 may be also configured to store information/data used by processing unit 224. For example, memory module 226 may be configured to store the corresponding relationship between poses of terminal 14 and poses of smart device 12.

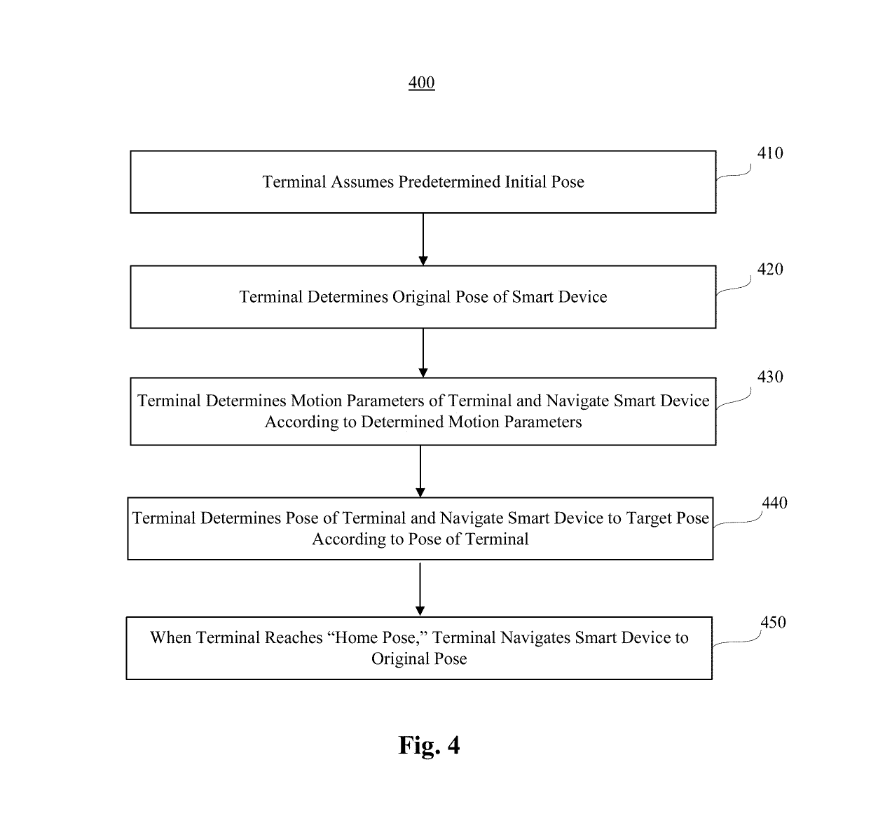

FIG. 4 is a flowchart of a method 400 for controlling a smart device, according to an exemplary embodiment. For example, method 400 may be used in terminal 14 (FIG. 3) to navigate smart device 12. For illustration purpose only, method 400 is described with the assumption that terminal 14 is a mobile phone and smart device 12 is a PTZ camera. Referring to FIG. 4, method 400 may include the following steps.

In step 410, terminal 14 may assume a predetermined initial pose. In exemplary embodiments, terminal 14 may be installed with an application for navigating smart device 12 based on the motion of terminal 14. The application may also provide a window for displaying the images shot by smart device 12. After the application is activated, terminal 14 may be aligned by the user in a predetermined initial pose. For example, the predetermined initial pose may be an upright position with the screen of terminal 14 facing toward the user. Aligning terminal 14 in the predetermined initial pose causes terminal 14 to be aligned with a predetermined reference frame, which may be later used to determine the motion parameters and pose of terminal 14. For example, in the reference frame, the x-axis may point from the screen of terminal 14 towards the user, the y-axis may points to the right of the user, and the z-axis may point to the upright direction.

In step 420, terminal 14 may determine the original pose of smart device 12. The original pose is the pose of smart device 12 when the application for navigating smart device 12 is started. Terminal 14 may send a signal to smart device to inquire the original pose of smart device 12. Subsequently, smart device 12 may report the original pose to terminal 14. In exemplary embodiments, terminal 14 may store a corresponding relationship between poses of terminal 14 and poses of smart device 12. In particular, this corresponding relationship may include the original pose of smart device 12 and a preset corresponding “home” pose of terminal 14. For example, the “home” pose may be the pose in which terminal 14 is placed in a horizontal plane, with the screen of terminal 14 facing vertically down. In this manner, when terminal 14 determines that it is in the “home” pose, terminal 14 may control, according to the corresponding relationship, smart device 12 to return to the original pose. Moreover, since the original pose of smart time 12 may be different each time when the application is started, terminal 14 may update the corresponding relationship when determining the original pose has changed.

In step 430, terminal 14 may determine the motion parameters of terminal 14 and navigate smart device 12 based on the determined motion parameters. Based on the signals generated by motion sensor 210, terminal 14 may determine the motion parameters in real time.

For example, terminal 14 may determine the angular velocity of terminal 14, including a yaw rate and a pitch rate. When terminal 14 pans in a horizontal plane, terminal 14 has a yaw rate. When terminal 14 tilts in a vertical plane, terminal 14 has a pitch rate. Each of the yaw rate and the pitch rate includes a direction and a magnitude. Accordingly, terminal 14 may control smart device 12 to pan/tilt according to the yaw/pitch rate of terminal 14. The panning/tilting of smart device 12 may obey a predetermined relationship with the yaw/pitch rate of terminal 14. In one embodiment, terminal 14 may control smart device 12 to pan/tilt in the same rate (i.e., the same direction and the same magnitude) as the yaw/pitch rate of terminal 14. Moreover, when terminal 14 has both a nonzero yaw rate and a nonzero pitch rate, terminal 14 may control smart device 12 to pan and tilt simultaneously.

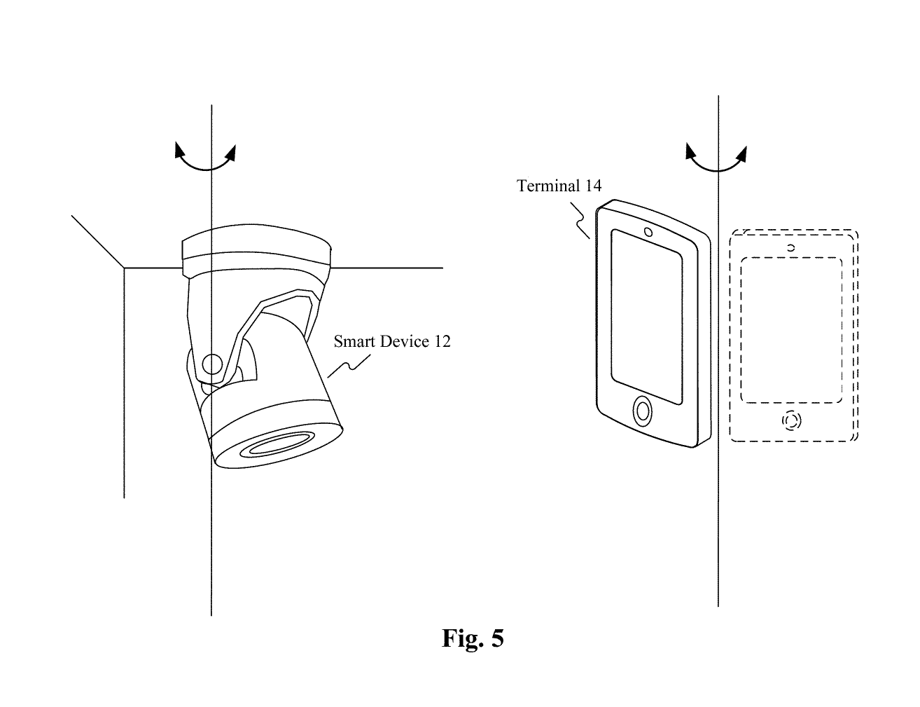

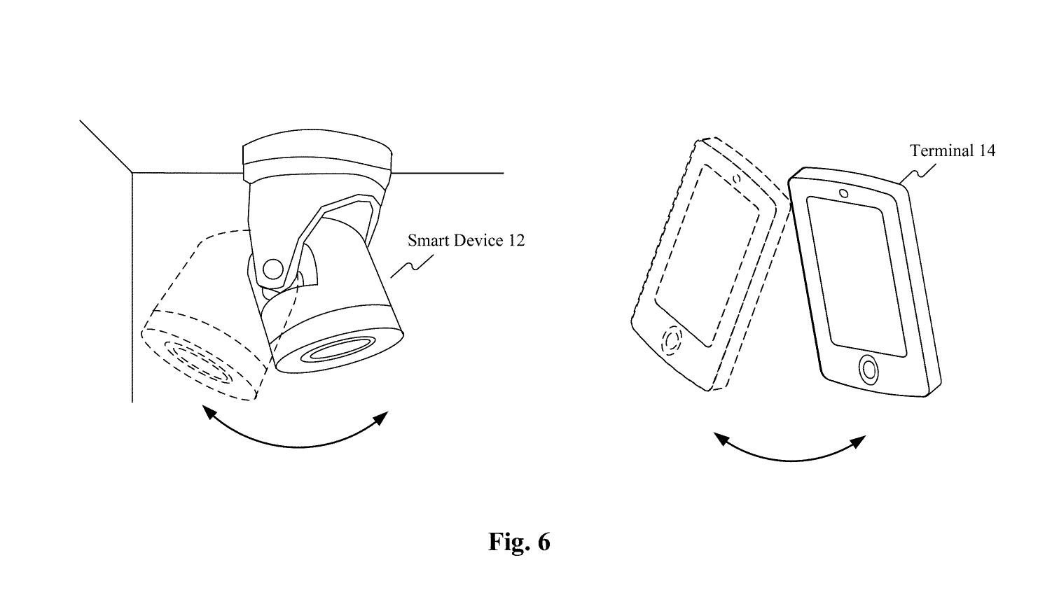

FIG. 5 is a schematic diagram illustrating panning smart device 12 based on the panning of terminal 14, according to an exemplary embodiment. Referring to FIG. 5, the user may pan terminal 14 horizontally to direct smart device 12 to pan to the left or right. FIG. 6 is a schematic diagram illustrating tilting smart device 12 based on the tilting of terminal 14, according to an exemplary embodiment. Referring to FIG. 6, the user may tilt terminal 14 vertically to direct smart device 12 to tilt up and down. Moreover, the user may pan and tilt terminal 14 simultaneously to direct smart device 12 to pan and tilt simultaneously.

Also for example, terminal 14 may determine the heading (i.e., the direction of the linear velocity or acceleration) of terminal 14 and zoom in/out smart device 12 according to the heading of terminal 14. In one embodiment, the user may move terminal 14 toward the user to direct smart device 12 to zoom in. Correspondingly, terminal 14 may simultaneously zoom in the images displayed on terminal 14. Also, the user may move terminal 14 away from the user to direct smart device 12 to zoom out. Correspondingly, terminal 14 may simultaneously zoom out the images displayed on terminal 14.

In step 440, terminal 14 may determine the pose of terminal 14 and navigate smart device 12 to a target pose according to the pose of terminal 14. The user often may move terminal 14 inadvertently and thus cause unwanted movement of smart device 12. For example, if the user repeatedly moves terminal 14 between the left and right and finally wants to position terminal 14 at the center, smart device 12 may also pan to the left and right repeatedly before settling at the center. Such unnecessary movement in smart device 12 may waste energy and speed up mechanical wear to smart device 12. To solve this problem, terminal 14 may implement an “intelligent” movement of smart device 12. Namely, instead of making the motion pattern of smart device 12 to follow the motion pattern of terminal 14, terminal 14 may move smart device 12 based on a final pose of terminal 14 after a series of movements of terminal 14.

For example, terminal 14 may first determine whether it has reached a final pose intended by the user. If terminal 14 comes to a stop after a series of continuous or consecutive movements, terminal 14 may detect the amount of time for which it has stopped. If the amount of time is longer than a predetermined threshold, for example, 5 seconds, terminal 14 may determine that terminal 14 has reached the intended final pose. Terminal 14 may then determine this final pose based on the motion parameters of terminal 14. Terminal 14 may integrate the linear accelerations and angular velocities to determine the final position and attitude of terminal 14, respectively. Subsequently, terminal 14 may determine a target pose for smart device 12 according to the preset corresponding relationship between poses of terminal 14 and smart device 12. In one embodiment, the target pose of smart device 12 may be set to have the same angular orientation as the final pose of terminal 14. Finally, terminal 14 may control smart device 12 to move to the target pose in a predetermined speed, such as a constant speed. In this manner, the unnecessary movements in smart device 12 may be avoided. Such “intelligent” movement can be applied to the panning, tilting, combination of panning and tilting, and/or zooming in/out of smart device 12.

The application running on terminal 14 may provide options for the user to choose between pegging the motion pattern of smart device 12 to the motion pattern of terminal 14 and enabling the “intelligent” movement. In some embodiments, terminal 14 may also be configured to automatically enable the “intelligent” movement when certain conditions occur. For example, when terminal 14 detects it swings at an abnormal frequency or moves in an abnormal speed, terminal 14 may implement the “intelligent” movement.

In step 450, when terminal 14 determine it reaches the “home pose,” terminal 14 may navigate smart device 12 to the original pose. Referring to the example described in step 420, when terminal 14 detects it is placed in a horizontal plane, with its screen facing vertically down, terminal 14 may direct smart device 12 to return to the original pose. Moreover, to avoid erroneous operations, terminal 14 may be configured to only initialize the restoration of the original pose after terminal 14 has stay at the “home” pose for longer than a predetermined amount of time, for example, 5 seconds.

In exemplary embodiments, there is also provided a non-transitory computer-readable medium storing instructions which, when executed, cause one or more processors to perform method 400, as discussed above. The computer-readable medium may include volatile or non-volatile, magnetic, semiconductor, tape, optical, removable, non-removable, and/or other types of computer-readable medium or computer-readable storage device. For example, the computer-readable medium may be memory module 226 and/or storage unit 228 having the computer instructions stored thereon, as disclosed in connection with FIG. 3. In some embodiments, the computer-readable medium may be a disc or a flash drive having the computer instructions stored thereon.

The disclosed exemplary embodiments may allow for convenient remote control of a smart device. First, since the motion-sensor based control of the smart device does not require a control menu or keyboard, the entire screen area of the smart device may be used to display the images taken by the smart device. For the same reason, the user can easily use one hand to control the motion of the smart device. Moreover, by tying the motion of the terminal to the motion of the smart device, the disclosed terminal allows the user to control the motion of the smart device preciously and intuitively. For example, the user may speed up or slow down the rotation of the smart device by doing the same with the terminal. Furthermore, the user does not need to control different movements, such as panning and tilting, of the smart device in separately steps. Instead, the user may direct the smart device to move to a target pose in one step. In particular, the “intelligent” movement feature provided by the present disclosure can avoid causing unnecessary or erroneously movements in the smart device, further improving the robustness of the disclosed embodiments.

Other embodiments of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact constructions that are described above and illustrated in the accompanying drawings, and that various modifications and changes can be made without departing from the scope thereof. It is intended that the scope of the invention should only be limited by the appended claims.

What is claimed is:

1. A terminal, comprising:
a sensor configured to generate a signal indicative of a motion parameter of the terminal;
a memory storing instructions; and
a processor configured to execute the instructions to:
determine the motion parameter based on the signal generated by the sensor; and
control a smart device to move according to the motion parameter.

2. The terminal according to claim 1, wherein the processor is further configured to execute the instructions to:
determine, according to the motion parameter, a resting pose of the terminal after a movement of the terminal;
determine, according to the resting pose of the terminal, a target pose of the smart device; and
control the smart device to move to the target pose.

3. The terminal according to claim 2, wherein the processor is further configured to execute the instructions to:
determine that the terminal stops moving for a first amount of time; and
if the first amount of time exceeds a threshold, determine that the terminal reaches the resting pose.

4. The terminal according to claim 2, wherein the resting pose includes at least one of a position or an attitude of the terminal.

5. The terminal according to claim 1, wherein the processor is further configured to execute the instructions to:
determine a first pose of the terminal according to the motion parameter of the terminal;
determine a second pose of the smart device according to the first pose and a corresponding relationship between poses of the terminal and poses of the smart device; and
control the smart device to move to the second pose.

6. The terminal according to claim 5, wherein the processor is further configured to execute the instructions to:
determine an original pose of the device at a predetermined point of time; and
update the corresponding relationship according to the determined original pose of the smart device.

7. The terminal according to claim 5, wherein the first pose includes at least one of a position or an attitude of the terminal.

8. The terminal according to claim 5, wherein the second pose includes at least one of a position or an attitude of the smart device.

9. The terminal according to claim 1, wherein
the motion parameter is a first yaw rate of the terminal; and
wherein the processor is further configured to execute the instructions to cause the smart device to pan in a second yaw rate.

10. The terminal according to claim 9, wherein the processor is further configured to execute the instructions to determine the second yaw rate according to the first yaw rate.

11. The terminal according to claim 1, wherein
the motion parameter is a first pitch rate of the terminal; and
wherein the processor is further configured to execute the instructions to cause the smart device to tilt in a second pitch rate.

12. The terminal according to claim 11, wherein the processor is further configured to execute the instructions to determine the second pitch rate according to the first pitch rate.

13. The terminal according to claim 1, wherein
the smart device is a camera, and
the motion parameter is a linear acceleration of the terminal; and
wherein the processor is further configured to execute the instructions to cause the smart device to zoom in or out according to a direction of the linear acceleration.

14. The terminal according to claim 1, wherein the processor is further configured to execute the instructions to:
generate a remote control signal for controlling the smart device to move according to the motion parameter; and
send the remote control signal to the smart device.

15. The terminal according to claim 1, wherein the motion sensor is a gyro sensor configured to sense an angular velocity of the terminal.

16. The terminal according to claim 1, wherein the motion parameter includes at least one of an angular velocity, a linear acceleration, a linear velocity, or a heading of the terminal.

17. The terminal according to claim 1, wherein the smart device is a pan-tilt-zoom camera.

18. A method for controlling a smart device, comprising:
generating a signal indicative of a motion parameter of a terminal;
determining the motion parameter based on the signal; and
controlling the smart device to move according to the motion parameter.

19. The method according to claim 18, further comprising:
determining, according to the motion parameter, a resting pose of the terminal after a movement of the terminal;
determining, according to the resting pose of the terminal, a target pose of the smart device; and
controlling the smart device to move to the target pose.

20. The method according to claim 19, wherein determining, according to the motion parameter, the resting pose of the terminal after the movement of the terminal further comprises:
determining that the terminal stops moving for a first amount of time; and
if the first amount of time exceeds a threshold, determining that the terminal reaches the resting pose.

21. The method according to claim 19, wherein the resting pose includes at least one of a position or an attitude of the terminal.

22. The method according to claim 18, further comprising:
determining a first pose of the terminal according to the motion parameter of the terminal;
determining a second pose of the smart device according to the first pose and a corresponding relationship between poses of the terminal and poses of the smart device; and
controlling the smart device to move to the second pose.

23. The method according to claim 22, further comprising:
determining an original pose of the device at a predetermined point of time; and
updating the corresponding relationship according to the original pose of the smart device.

24. The method according to claim 22, wherein the first pose includes at least one of a position or an attitude of the terminal.

25. The method according to claim 22, wherein the second pose includes at least one of a position or an attitude of the smart device.

26. The method according to claim 18, wherein
the motion parameter is a first yaw rate of the terminal; and
wherein controlling the smart device to move according to the motion parameter further comprises:
causing the smart device to pan in a second yaw rate.

27. The method according to claim 26, further comprising:
determining the second yaw rate according to the first yaw rate.

28. The method according to claim 18, wherein
the motion parameter is a first pitch rate of the terminal; and
wherein controlling the smart device to move according to the motion parameter further comprises:
causing the smart device to tilt in a second yaw rate.

29. The method according to claim 28, further comprising:
determining the second pitch rate according to the first pitch rate.

30. The method according to claim 18, wherein
the smart device is a camera, and
the motion parameter is a linear acceleration of the terminal; and
wherein controlling the smart device to move according to the motion parameter further comprises:
causing the smart device to zoom in or out according to a direction of the linear acceleration.

31. The method according to claim 18, wherein controlling the smart device to move according to the motion parameter further comprises:
generating a remote control signal for controlling the smart device to move according to the motion parameter; and
sending the remote control signal to the smart device.

32. The method according to claim 18, wherein the motion parameter includes at least one of an angular velocity, a linear acceleration, a linear velocity, or a heading of the terminal.

33. A non-transitory computer-readable storage medium storing instructions for controlling a smart device, the instructions causing a processor to perform operations comprising:
generating a signal indicative of a motion parameter of a terminal;
determining the motion parameter based on the signal; and
controlling the smart device to move according to the motion parameter.

34. The non-transitory computer-readable storage medium of claim 33, further comprising:
determining, according to the motion parameter, a resting pose of the terminal after a movement of the terminal;
determining, according to the resting pose of the terminal, a target pose of the smart device; and
controlling the smart device to move to the target pose.

35. The non-transitory computer-readable storage medium of claim 34, wherein determining, according to the motion parameter, the resting pose of the terminal after the movement of the terminal further comprises:
determining that the terminal stops moving for a first amount of time; and
if the first amount of time exceeds a threshold, determining that the terminal reaches the resting pose.

36. The non-transitory computer-readable storage medium of claim 34, wherein the resting pose includes at least one of a position or an attitude of the terminal.
